(19) United States
(12) Patent Application Publication
(10) Pub. No.: US 2026/0321748 A1
(43) Pub. Date: Oct. 15, 2026

(54) ENERGY STORAGE MODULE AND ENERGY STORAGE SYSTEM INCLUDING THE SAME

(71) Applicant: Samsung SDI Co., Ltd., Yongin-si (KR)

(72) Inventors: Jae Seung Kim, Suwon-si (KR); Tae Jin Kim, Suwon-si (KR)

(73) Assignee: Samsung SDI Co., Ltd., Yongin-si (KR)

(21) Appl. No.: 19/564,004

(22) Filed: Mar. 11, 2026

(30) Foreign Application Priority Data
Apr. 14, 2025 (KR) 10-2025-0048197

(51) Int. Cl. H01M 10/42; H01M 10/658; H01M 50/15; H01M 50/209; H01M 50/30; H01M 50/507

(52) U.S. Cl. CPC H01M 10/425; H01M 10/658; H01M 50/15; H01M 50/209; H01M 50/394; H01M 50/507; H01M 2010/4271; H01M 2010/4278

(57) ABSTRACT

Provided are an energy storage module and an energy storage system including the same. The energy storage module according to embodiments includes a plurality of batteries, a plurality of bus bars that electrically connect the plurality of batteries, and a wiring circuit member that transmits status information of each of the plurality of batteries to a battery management system (BMS) through a plurality of wiring lines connected to each of the plurality of bus bars, wherein the wiring circuit member includes an upper wiring sub-circuit member and a lower wiring sub-circuit member that each includes a part of the plurality of wiring lines and are substantially vertically stacked.

### CROSS-REFERENCE TO RELATED APPLICATIONS

This present application claims priority to and the benefit under 35 U.S.C. §119(a)-(d) of Korean Patent Application No. 10-2025-0048197, filed on Apr. 14, 2025, in the Korean Intellectual Property Office, the entire disclosure of which is incorporated herein by reference.

### FIELD

The present disclosure relates a secondary battery, and more specifically, to an energy storage module including a plurality of secondary batteries and an energy storage system including a plurality of energy storage modules.

### BACKGROUND

Secondary batteries are batteries that can be charged and discharged, unlike primary batteries that cannot be recharged. Low-capacity secondary batteries (hereinafter also simply referred to as ‘batteries’) are used in small portable electronic devices such as smartphones, feature phones, notebook computers, digital cameras, and camcorders, and high-capacity secondary batteries are widely used as power sources for driving motors in hybrid vehicles, electric vehicles, and the like and as batteries for energy storage systems (ESSs).

An energy storage system is a system that can store surplus electricity or electricity produced using renewable energy. The energy storage system may include a plurality of energy storage modules. Also, each energy storage module may include dozens or more of electrically interconnected batteries, and is also referred to as a battery module or battery pack.

A battery management system (BMS) may monitor the voltage and temperature of the batteries constituting an energy storage module and also control the charging and discharging of the batteries. To this end, the energy storage module includes a sensing circuit member for electrically connecting the battery management system and a plurality of batteries. As the number of batteries included in the energy storage module increases, the number of wiring lines included in the sensing circuit member also inevitably increases. For example, when the number of batteries connected in series is around 50, the number of wiring lines required to connect each of these batteries to the battery management system may be around 60 or more.

The herein-described information disclosed in the background technology of this disclosure is only intended to improve understanding of the background of the present disclosure and therefore may include information that does not constitute related art.

### SUMMARY

The present disclosure is directed to providing an energy storage module, which is capable of improving the thermal stability of a sensing circuit member that connects a plurality of batteries to a battery management system, and an energy storage system including the same.

However, technical problems to be solved by the present disclosure are not limited to the problems described herein, and other problems that are not described may be clearly understood by those skilled in the art from the description of the disclosure described herein.

According to embodiments of the present disclosure, there is provided an energy storage module including a plurality of batteries, a plurality of bus bars that electrically connect the plurality of batteries, and a wiring circuit member (for example, sensing circuit member) that transmits status information of each of the plurality of batteries to a battery management system (BMS) through a plurality of wiring lines connected to each of the plurality of bus bars, wherein the wiring circuit member includes an upper wiring sub-circuit member (for example, upper sensing sub-circuit member) and a lower wiring sub-circuit member (for example, lower sensing sub-circuit member) that each includes a part of the plurality of wiring lines and are substantially vertically stacked.

According to an aspect of the embodiments, the wiring circuit member may further include a heat insulating member interposed between the upper wiring sub-circuit member and the lower wiring sub-circuit member. For example, the heat insulating member may include a mica sheet.

According to another aspect of the embodiments, the wiring circuit member may include an insulating film in which the plurality of wiring lines are embedded. For example, the insulating film may include a coverlay.

According to still another aspect of the embodiments, the upper wiring sub-circuit member and the lower wiring sub-circuit member may each include a flat cable. For example, the flat cable may include one or more of a flexible flat cable (FFC), a flexible printed circuit (FPC) and a flexible die-cut circuit (FDC).

According to embodiments of the present disclosure, there is provided an energy storage module including a plurality of prismatic batteries, each of which has a first terminal and a second terminal provided at edges of both sides of a cap plate and arranged in a row in a first direction, a plurality of bus bars that include a first row bus bar and a second row bus bar, each of which is arranged in a row substantially in the first direction, and electrically connects the first terminal and the second terminal of adjacent prismatic batteries among the plurality of prismatic batteries, and a wiring circuit member that transmits status information of each of the plurality of prismatic batteries to a battery management system (BMS) through a plurality of wiring lines connected to the plurality of bus bars, extends substantially in the first direction, and is disposed between the first row bus bar and the second row bus bar, wherein the wiring circuit member includes an upper wiring sub-circuit member and a lower wiring sub-circuit member that each includes a part of the plurality of wiring lines and are substantially vertically stacked.

According to aspects of the embodiments, the wiring circuit member may further include a heat insulating member interposed between the upper wiring sub-circuit member and the lower wiring sub-circuit member. For example, the heat insulating member may include a mica sheet.

According to aspects of the embodiments, the wiring circuit member may include an insulating film in which the plurality of wiring lines are embedded. For example, the insulating film may include a coverlay.

According to still aspects of the embodiments, the upper wiring sub-circuit member and the lower wiring sub-circuit member may each includes a flat cable. For example, the flat cable may include one or more of a flexible flat cable (FFC), a flexible printed circuit (FPC), and a flexible die-cut circuit (FDC).

According to aspects of the embodiments, the upper wiring sub-circuit member may include a first row upper wiring sub-circuit member disposed adjacent to the first row bus bar and a second row upper wiring sub-circuit member disposed adjacent to the second row bus bar, and the lower wiring sub-circuit member may include a first row lower wiring sub-circuit member disposed adjacent to the first row bus bar and a second row lower wiring sub-circuit member disposed adjacent to the second row bus bar.

According to aspects of the embodiments, the cap plate further may include a vent provided between the first terminal and the second terminal, the first row upper wiring sub-circuit member and the second row upper wiring sub-circuit member may be spaced apart from one another so as not to overlap the vent, and the first row lower wiring sub-circuit member and the second row lower wiring sub-circuit member may be spaced apart from one another so as not to overlap the vent.

According to aspects of the embodiments, the wiring circuit member may further include a first heat insulating member interposed between the first row upper wiring sub-circuit member and the first row lower wiring sub-circuit member, and a second heat insulating member interposed between the second row upper wiring sub-circuit member and the second row lower wiring sub-circuit member.

According to embodiments of the present disclosure, there is provided an energy storage system including a rack on which a plurality of energy storage modules are mounted, wherein each of the plurality of energy storage modules may include a plurality of batteries, a plurality of bus bars that electrically connect the plurality of batteries, and a wiring circuit member that transmits status information of each of the plurality of batteries to a battery management system (BMS) through a plurality of wiring lines connected to each of the plurality of bus bars, wherein the wiring circuit member includes an upper wiring sub-circuit member and a lower wiring sub-circuit member that each includes a part of the plurality of wiring lines and are substantially vertically stacked.

### BRIEF DESCRIPTION OF THE DRAWINGS

The following drawings attached to the present specification illustrate exemplary embodiments of the present disclosure and further describe aspects and features of the present disclosure together with the detailed description of the present disclosure. Thus, the present disclosure should not be construed as being limited to the drawings, in which:

FIG. 1 is a perspective view schematically illustrating an example of an energy storage system according to embodiments of the present disclosure;

FIG. 2 is a perspective view schematically illustrating an example of an energy storage module according to embodiments of the present disclosure;

FIG. 3 is a partially exploded perspective view schematically illustrating an internal structure of the energy storage module in FIG. 2;

FIG. 4 is a cross-sectional view illustrating an example of a battery included in the energy storage module in FIG. 3;

FIG. 5 is a view illustrating an example of an electrode assembly included in the battery in FIG. 4;

FIG. 6 is an exploded perspective view illustrating a bus bar and a wiring circuit member in the energy storage module in FIG. 3 in more detail;

FIG. 7 is an enlarged perspective view illustrating two sensing circuit members illustrated in FIG. 6; and

FIG. 8 is a cross-sectional view along line VIII-VIII in FIG. 7.

### DETAILED DESCRIPTION

Hereinafter, exemplary embodiments of the present disclosure will be described in detail with reference to the attached drawings. Prior to this, terms or words used in this specification and claims should not be interpreted limited to ordinary or dictionary meanings and should be interpreted as meanings and concepts consistent with the technical idea of this disclosure based on the principle that the inventor can properly define the concepts of terms in order to describe his or her disclosure in the best way. Accordingly, it is to be understood that the embodiments described herein, and the configurations illustrated in the drawings are only some of the most exemplary embodiments of the disclosure and do not represent all of the technical ideas of the disclosure, and that there may be various equivalents and modifications that may replace them at the time of filing.

Furthermore, when used herein, the terms “comprise or include” and/or “comprising or including” specify the presence of the stated shapes, numbers, steps, operations, members, elements, and/or groups thereof and are not intended to exclude the presence or addition of one or more other shapes, numbers, steps, operations, members, elements, and/or groups thereof.

In addition, in order to help understand the disclosure, the attached drawings are not drawn to actual scale, and the dimensions of some components may be exaggerated. In addition, the same reference numbers may be assigned to the same components in different embodiments.

The statement that two objects for comparison are “equal” means “substantially the same.” Therefore, substantially the same may include deviations that are considered low in the art, for example, deviations of less than 5%. Additionally, uniformity of a parameter over a given region may mean uniformity from an average perspective.

Although first, second, and the like are used to describe various components, the components are not limited by these terms. These terms are used only to distinguish one component from another, and unless otherwise specifically stated, it is to be understood that a first component may also be a second component.

Throughout the specification, unless otherwise specifically stated, each element may be singular or plural.

When an arbitrary component is disposed “on (or under)” a first component or “above (or below)” the first component, it can mean not only that the arbitrary component is disposed in contact with the top (or bottom) of the first component, but also that a second component can be interposed between the first component and the arbitrary component disposed on (or under) the first component.

Further, when it is disclosed that a certain component is “connected,” “coupled,” coupled or “linked” to another component, it should be understood that the components may be directly connected or linked to one another, but another component may be “interposed” between the components, or the components may be “connected,” “coupled,” or “linked” through another component. In addition, when a portion is “electrically coupled” to another part, this includes not only the case where it is “directly connected” but also the case where it is “connected” with another member or element interposed therebetween.

Throughout the specification, “A and/or B” means A, B, or A and B unless otherwise stated to the contrary. That is, “and/or” includes any or all combinations of a plurality of listed items. When “C to D” is stated, it means greater than or equal to C and less than or equal to D unless otherwise specifically stated.

In the present specification, “a combination thereof” may mean a mixture, a laminate, a composite, a copolymer, an alloy, a blend, and a reaction product of components.

The terms used in the present specification are intended to describe the embodiments of the present disclosure, and are not intended to limit the present disclosure.

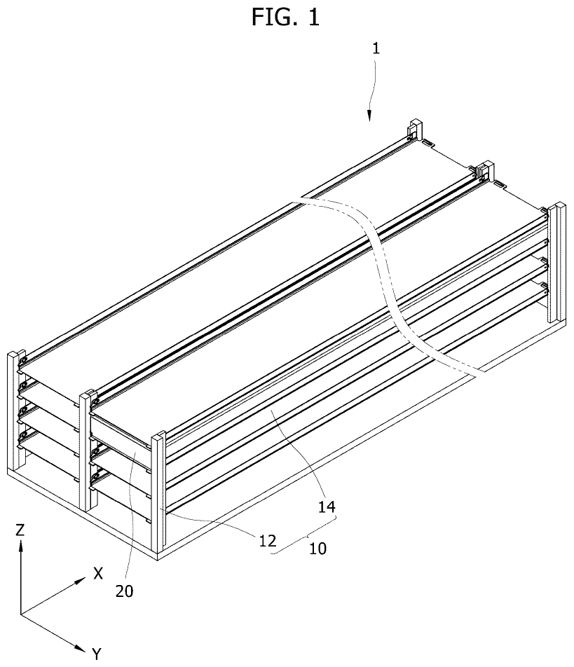

FIG. 1 is a perspective view schematically illustrating an example of an energy storage system according to embodiments of the present disclosure.

Referring to FIG. 1, an energy storage system 1 includes a rack 10 and an energy storage module 20. In FIG. 1, only one energy storage module 20 is illustrated as being mounted in one rack 10, but this is merely exemplary. Typically, the energy storage system 1 may include one or more racks 10, and each rack 10 may have one or more energy storage modules 20 mounted therein.

The rack 10 provides a space in which the energy storage module 20 may be mounted inside and/or on top. The rack 10 may include a rack frame 12 and a rack shelf 14. In FIG. 1, the rack 10 is illustrated as having two columns in a Y-axis direction and four tiers in a Z-axis direction, but this is merely an example. The overall structure of the rack 10 may vary depending on the number of energy storage modules 20 included in the energy storage system 1.

The rack frame 12 may form the overall exterior of the rack 10 and have the form of a hollow box or frame. The rack frame 12 may include a plate-shaped base parallel to the XY plane and a column-shaped support member installed to extend from the base in the Z-axis direction, as illustrated in FIG. 1.

The rack frame 12 may be disposed indoors in a building, or inside a container, cabinet, or the like. The rack frame 12, especially the support member, may be formed of a high-strength material such as steel to prevent damage due to the load applied by the energy storage module 20. The shape of the space defined by the rack frame 12 may be designed to have various shapes, such as a polyhedron, cylinder, or the like in addition to the rectangular parallelepiped shape illustrated in FIG. 1.

The rack shelf 14 is a flat plate-shaped member installed parallel to the XY plane within the rack frame 12, and is a structure that supports the energy storage module 20 from below. In FIG. 1, eight rack shelves 14 are illustrated as being installed in two columns and four tiers, but this is merely exemplary. The number of columns and/or tiers of the rack shelves 14 installed within the rack frame 12 may vary depending on the number of energy storage modules 20 included in the energy storage system 1 and the structure of the rack 10.

The shape of the rack shelf 14 may be implemented in various forms and is not particularly limited. For example, as illustrated in FIG. 1, the rack shelf 14 may be installed as a single flat plate between the adjacent support members of the rack frames 12 to support the entire bottom surface of the energy storage module 20. Alternatively, the rack shelves 14 may be installed in pairs on facing sides of the adjacent support members of the rack frames 12 in the Y-axis direction to support both edges of the bottom surface of the energy storage module 20.

One or more energy storage modules 20 may be mounted on the rack shelf 14. For example, only one energy storage module 20 may be mounted on one rack shelf 14. However, the present disclosure is not limited thereto, and two or more energy storage modules 20 arranged in one direction, for example, in an X-axis direction may be mounted on one rack shelf 14.

Also, the energy storage modules 20 may be vertically stacked inside the rack frame 12. A predetermined space may be present between the vertically stacked energy storage modules 20, that is, between the energy storage module 20 and the rack shelf 14 located above the energy storage module 20. Also, the energy storage modules 20, which are vertically stacked in a Z-axis direction, may be disposed in a plurality of columns, such as one or two or more columns in the Y-axis direction based on FIG. 1.

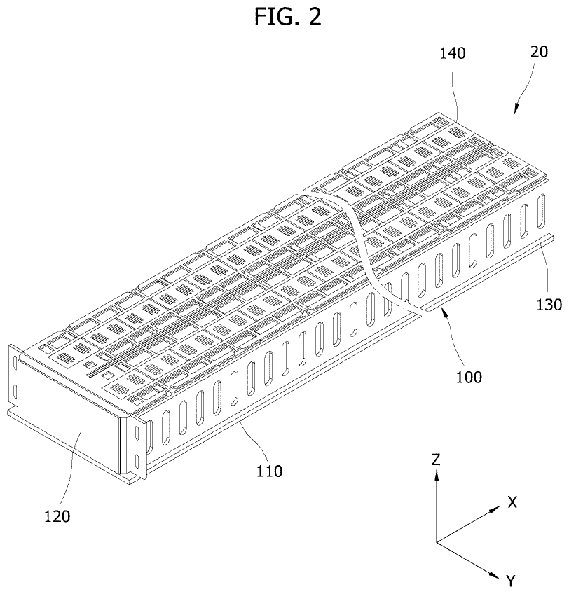

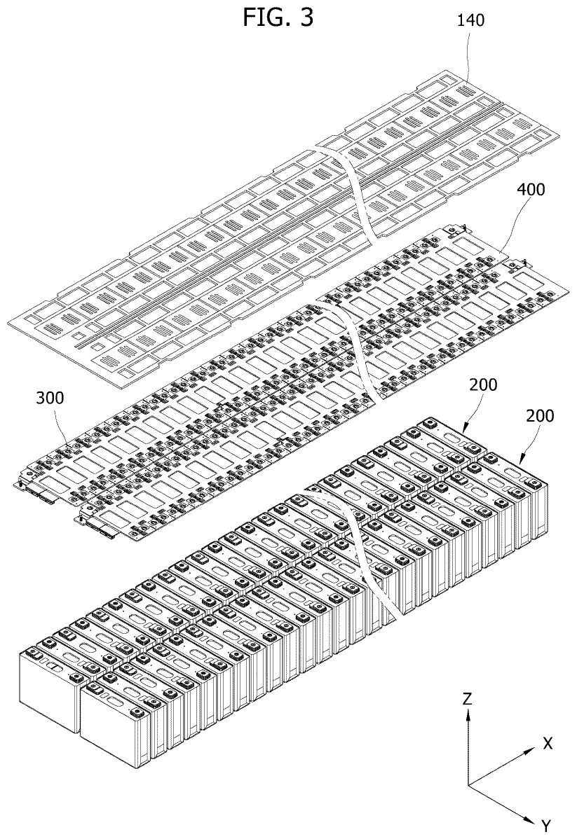

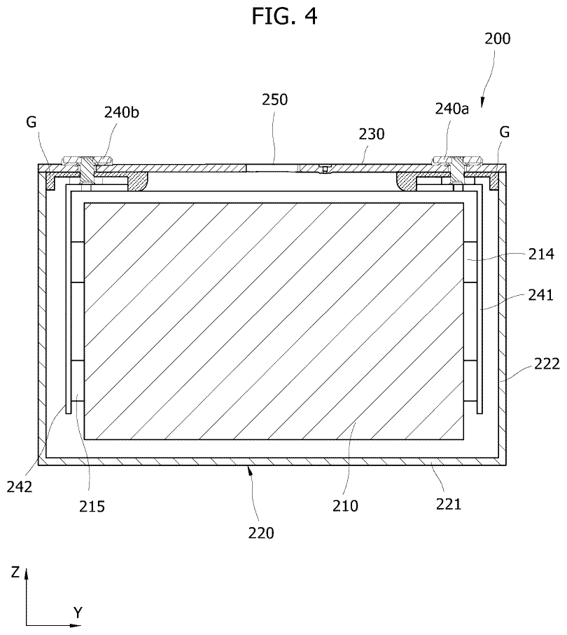

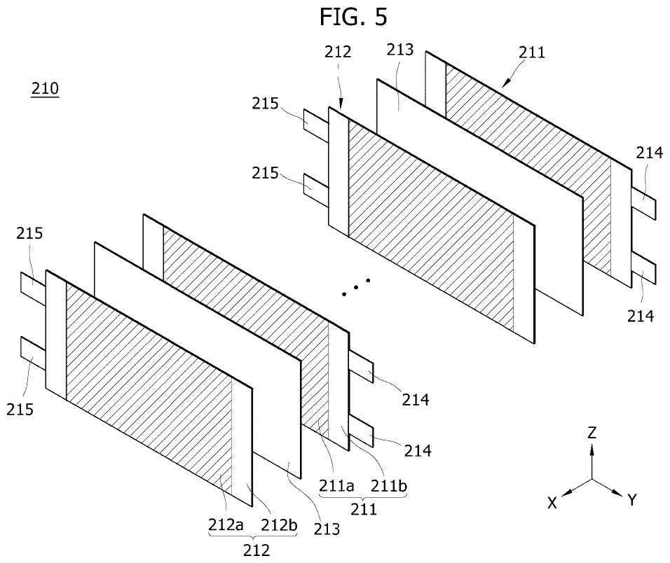

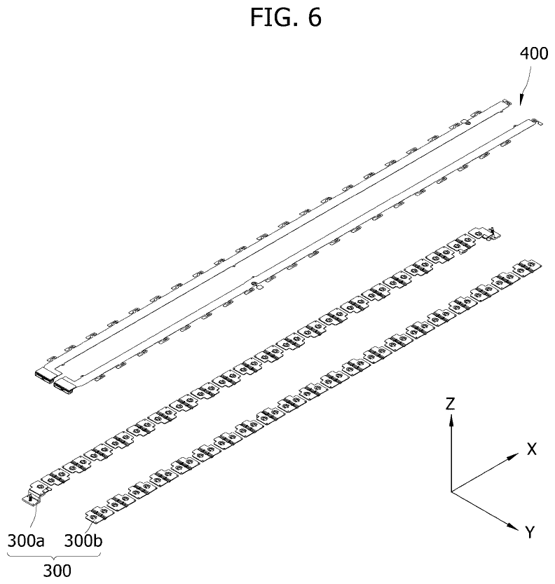

FIG. 2 is a perspective view illustrating an example of an energy storage module according to embodiments of the present disclosure. FIG. 3 is a partially exploded perspective view schematically illustrating an internal structure of the energy storage module in FIG. 2. FIG. 4 is a cross-sectional view illustrating an example of a battery included in the energy storage module in FIG. 3. FIG. 5 is a view illustrating an example of an electrode assembly included in the battery in FIG. 4. FIG. 6 is an exploded perspective view illustrating a bus bar and a wiring circuit member (for example, sensing circuit member) in the energy storage module in FIG. 3 in more detail.

Referring to FIGS. 2 to 6, the energy storage module 20 includes a module case 100, a battery 200, a bus bar 300, and a sensing circuit member 400. The energy storage module 20 may store electrical energy through the charging operation of the battery 200, and supply electrical energy to an external device through the discharging operation of the battery 200.

The module case 100 provides a space that may accommodate a plurality of batteries 200 therein. The module case 100 may fix the positions of the plurality of batteries 200 and protect the batteries 200 from external impacts or impurities.

The shape of the module case 100 is not particularly limited. For example, the module case 100 may have an overall rectangular parallelepiped shape and an open upper side. The module case 100 may include a bottom plate 110, a pair of end plates 120, and a pair of side plates 130. Unlike as shown in FIG. 2, the side of the module case 100 does not necessarily have to be plate-shaped, and may also be configured as a combination of bar-shaped frames capable of fixing a battery. The module case 100 may further include a top plate 140 that covers an upper side of the battery 200.

The battery 200 may function as a unit structure that stores and supplies power in the energy storage module 20. The plurality of batteries 200 may be disposed inside the module case 100. The plurality of batteries 200 may be arranged in various ways inside the module case 100. More specifically, the plurality of batteries 200 may be arranged in a first direction, for example, the X-axis direction, to form a row of batteries (RB). The number of batteries 200 constituting the row of batteries (RB) is not particular limited, but it may include several dozen or more batteries 200. For example, the row of batteries (RB) may be composed of 50 or more batteries 200. Although not illustrated in the drawings, spacers for ensuring thermal and electrical insulation may be additionally provided between the batteries 200 constituting the row of batteries (RB).

The energy storage module 20 may include one or more rows of batteries (RB). In FIG. 3, the energy storage module 20 is illustrated as including two rows of batteries (RB) spaced apart at a predetermined interval, but this is merely an example. The energy storage module 20 may include only one row of batteries (RB) or three or more rows of batteries (RB).

Hereinafter, the battery 200 is described as a prismatic lithium ion battery as an example. However, this is exemplary, and the battery 200 may be a lithium polymer battery or a cylindrical battery.

The battery 200 includes an electrode assembly 210, a case 220, a cap plate 230, terminals 240a and 240b, and a vent 250.

The electrode assembly 210 may function as a unit structure that performs charging and discharging operations of power in the battery 200. The electrode assembly 210 may be housed inside the case 220. The electrode assembly 210 may include a first electrode 211, a second electrode 212, and a separator 213.

Hereinafter, the electrode assembly 210 is described as a stack type as an example in which the first electrode 211, the second electrode 212, and the separator 213 are alternately stacked in the X-axis direction. However, the structure of the electrode assembly 210 is not limited thereto, and may be a jelly-roll type in which the first electrode 211, the separator 213, the second electrode 212, and the separator 213, each in the form of a sheet, are sequentially stacked and wound around a winding axis.

The first electrode 211 may function as a positive electrode of the electrode assembly 210. In this case, the first electrode 211 may be formed in the form of a foil including a metallic material such as aluminum or an aluminum alloy. The type, size, and shape of the first electrode 211 are not particularly limited as long as it is conductive and does not cause a chemical change in the battery 200. A plurality of first electrodes 211 may be provided, and the number of first electrodes 211 may be designed to vary depending on the charging capacity of the battery, or the like.

A first active material layer 211a may be formed on at least a portion of the first electrode 211. The first active material layer 211a may be formed on both surfaces of the first electrode 211, or alternatively, may be formed on only one surface of the first electrode 211. Since the first electrode 211 functions as a positive electrode, the first active material layer 211a may include a positive electrode active material.

As the positive electrode active material, a compound capable of reversible intercalation and deintercalation of lithium (lithiated intercalation compound) may be used. Specifically, one or more of composite oxides of lithium and a metal selected from cobalt, manganese, nickel, iron, and a combination thereof may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM). Here, 0<x<1, 0<y<1, 0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM) and include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM).

The first active material layer 211a may further include a positive electrode conductive material. The positive electrode conductive material is used to impart conductivity to the first active material layer 211a, and any material that does not cause chemical changes and is electronically conductive may be used. Examples of the positive electrode conductive material may include carbon-based materials such as natural graphite, artificial graphite, carbon black, acetylene black, Ketjen black, carbon fibers, carbon nanofibers, or carbon nanotubes; metal-based materials in the form of metal powder or metal fibers containing copper, nickel, aluminum, or silver; conductive polymers such as polyphenylene derivatives; or mixtures thereof.

The first active material layer 211a may further include a positive electrode binder. The positive electrode binder serves to attach particles constituting the positive electrode active material to one another well and also to attach the positive electrode active material to the first electrode well. Examples of the positive electrode binder include a non-aqueous binder, an aqueous binder, a dry binder, or a combination thereof.

The first electrode 211 may include a first uncoated portion 211b to which the first active material layer 211a is not applied. The first uncoated portion 211b may be disposed in one end region of the first electrode 211 facing the Y-axis direction. However, the first uncoated portion 211b is not limited to this configuration, and may be formed over the entire edge region of the first electrode 211. Depending on the type of prismatic battery, the first uncoated portion 211b may also be disposed in one end region of the first electrode 211 facing the Z-axis direction.

The second electrode 212 may function as a negative electrode of the electrode assembly 210. In this case, the second electrode 212 may be formed to have the form of a foil including a metallic material such as copper, a copper alloy, nickel, or a nickel alloy. The type, size, and shape of the second electrode 212 are not particularly limited as long as it is conductive and does not cause a chemical change in the battery 200.

A second active material layer 212a may be formed on at least a portion of the second electrode 212. The second active material layer 212a may be formed on both surfaces of the second electrode 212, or alternatively, may be formed on only one surface of the second electrode 212.

Since the second electrode 212 functions as a negative electrode, the second active material layer 212a may include a negative electrode active material. The negative electrode active material may include a material capable of reversibly intercalating and deintercalating lithium ions, lithium metal, an alloy of lithium and a metal, a material capable of doping and dedoping lithium, or a transition metal oxide. The material capable of reversibly intercalating/deintercalating lithium ions may be a carbon-based negative electrode active material, for example, crystalline carbon, amorphous carbon, or a combination thereof. Examples of the crystalline carbon may include graphite such as amorphous, plate-shaped, flaky, spherical, or fibrous natural graphite or artificial graphite, and examples of the amorphous carbon may include soft carbon or hard carbon, mesophase pitch carbide, calcined coke, or the like.

An alloy of lithium and a metal selected from Na, K, Rb, Cs, Fr, Be, Mg, Ca, Sr, Si, Sb, Pb, In, Zn, Ba, Ra, Ge, Al and Sn may be used as the alloy of lithium and a metal.

As the material capable of doping and dedoping lithium, a Si-based negative electrode active material or Sn-based negative electrode active material may be used. The Si-based negative electrode active material may include silicon, a silicon-carbon composite, SiOₓ (0<x<2), a Si-Q alloy (where Q is selected from alkali metals, alkaline earth metals, group 13 elements, group 14 elements (excluding Si), group 15elements, group 16 elements, transition metals, rare earth elements, and a combination thereof), or a combination thereof. The Sn-based negative electrode active material may include Sn, SnO₂, a Sn-based alloy, or a combination thereof.

The silicon-carbon composite may be a composite of silicon and amorphous carbon. According to embodiments, the silicon-carbon composite may be in the form of silicon particles whose surfaces are coated with amorphous carbon. For example, the silicon-carbon composite may include a secondary particle (a core) in which silicon primary particles are assembled and an amorphous carbon coating layer (a shell) located on the surface of the secondary particle. The amorphous carbon may also be located between the silicon primary particles so that, for example, the silicon primary particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer located on a surface of the core.

The Si-based negative electrode active material or the Sn-based negative electrode active material may be used in combination with the carbon-based negative electrode active material.

The second active material layer 212 may further include a negative electrode conductive material and a negative electrode binder. The negative electrode conductive material may be used to impart conductivity to the second active material layer 212, and any electronically conductive material that does not cause a chemical change may be used. Examples of the negative electrode conductive material may include a carbon-based material such as natural graphite, artificial graphite, carbon black, acetylene black, Ketjen black, carbon fibers, carbon nanofibers, and carbon nanotubes, a metal-based material in the form of a metal powder or metal fiber containing copper, nickel, aluminum, silver, etc., a conductive polymer such as a polyphenylene derivative, or a mixture thereof.

The negative electrode binder serves to attach particles constituting the negative electrode active material to one another well, and also to attach the negative electrode active material well to the second electrode. Examples of the negative electrode binder include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, and a combination thereof.

When the aqueous binder is used as the negative electrode binder, a cellulose-based compound capable of imparting viscosity may be further included. This cellulose-based compound may be used by mixing one or more of carboxymethyl cellulose, hydroxypropyl methyl cellulose, methyl cellulose, or alkali metal salts thereof. Na, K, or Li may be used as the alkali metal.

The dry binder is a polymer material capable of being fiberized and may be, for example, polytetrafluoroethylene, polyvinylidene fluoride, a polyvinylidene fluoride-hexafluoropropylene copolymer, polyethylene oxide, or a combination thereof.

The second electrode 212 may include a second uncoated portion 212b to which the second active material layer 212a is not applied. The second uncoated portion 212b may be disposed in one end region of the second electrode 212 facing the Y-axis direction. However, the second uncoated portion 212b is not limited to this configuration, and may be formed over the entire edge region of the second electrode 212. Depending on the type of prismatic battery, the second uncoated portion 212b may be disposed in one end region of the second electrode 212 facing the Z-axis direction.

The separator 213 may be disposed between the first electrode 211 and the second electrode 212. The separator 213 may perform the function of preventing a short circuit between the first electrode 211 and the second electrode 212 while allowing lithium ions to move between the first electrode 211 and the second electrode 212. The separator 213 may be disposed to completely cover a surface region of the electrode assembly 210. Accordingly, the separator 213 may prevent the first electrode 211 and the second electrode 212 from being directly exposed to the outside of the electrode assembly 210.

As the separator 213 polyethylene, polypropylene, polyvinylidene fluoride or multilayer films of two or more layers thereof may be used, and mixed multilayer films such as a polyethylene/polypropylene two-layer separator, a polyethylene/polypropylene/polyethylene three-layer separator, a polypropylene/polyethylene/polypropylene three-layer separator, etc. may be used.

The separator 213 may include a porous substrate and a coating layer containing an organic material, an inorganic material, or a combination thereof, located on one or both surfaces of the porous substrate.

The porous substrate may be a polymer film formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, and polytetrafluoroethylene (e.g. Teflon), or a copolymer or mixture of two or more thereof.

The organic material may include a polyvinylidene fluoride-based polymer or a (meth) acryl-based polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. The organic material and the inorganic material may be present as a mixture in a single coating layer or may be present in a form in which a coating layer including an organic material and a coating layer including an inorganic material are stacked.

The electrode assembly 210 may further include a first tab 214 and a second tab 215.

The first tab 214 may be connected to the first electrode 211. The first tab 214 may have the form of a foil extending in a direction parallel to the Y-axis direction from the first uncoated portion 211b of the first electrode 211. The first tab 214 may have a roughly rectangular shape. However, the shape of the first tab 214 is not limited thereto and may be designed to have various shapes.

The first tab 214 may be integrally formed with the first electrode 211. For example, the first tab 214 may be the remaining region of the first uncoated portion 211b that remains after a portion of the first uncoated portion 211b is cut or removed by notching or the like. Alternatively, the first tab 214 may be separately manufactured from the first electrode 211 and then connected to the first uncoated portion 211b by welding or the like. A material of the first tab 214 may be the same as that of the first electrode 211.

A plurality of first tabs 214 may be provided. Each of the first tabs 214 may individually extend from the first uncoated portion 211b of a different first electrode 211. Adjacent first tabs 214 may be disposed to face one another in the X-axis direction. That is, the plurality of first tabs 214 may be arranged in the X-axis direction. Adjacent first tabs 214 may be disposed parallel to one another. Adjacent first tabs 214 may be in contact with one another, and may also be spaced apart from one another by a thickness of the separator 213.

A plurality of first tabs 214 may be provided on each first electrode 211. For example, a pair of first tabs 214 may be provided on each first electrode 211. The pair of first tabs 214 provided on each first electrode 211 may be arranged in a row in the Z-axis direction.

The second tab 215 may be connected to the second electrode 212. The second tab 215 may have the form of a foil extending from the second uncoated portion 212b of the second electrode 212 in a direction parallel to a Y-axis direction. Extension directions of the first tab 214 and the second tab 215 may be opposite to one another. The second tab 215 may have a roughly rectangular shape. However, the shape of the second tab 215 is not limited thereto, and may be designed to have various shapes.

The second tab 215 may be integrally formed with the second electrode 212. For example, the second tab 215 may be the remaining region of the second uncoated portion 212b that remains after a portion of the second uncoated portion 212b is cut or removed by notching or the like. Alternatively, the second tab 215 may be separately manufactured from the second electrode 212 and then connected to the second uncoated portion 212b by welding or the like. A material of the second tab 215 may be the same as that of the second electrode 212.

A plurality of second tabs 215 may be provided. Each of the second tabs 215 may individually extend from the second uncoated portion 212b of a different second electrode 212. Adjacent second tabs 215 may be disposed to face one another in the X-axis direction. That is, the plurality of second tabs 215 may be arranged in the X-axis direction. Adjacent second tabs 215 may be disposed parallel to one another. Adjacent second tabs 215 may be in contact with one another, and may also be spaced apart from one another by a thickness of the separator 213.

A plurality of second tabs 215 may be provided on each second electrode 212. For example, a pair of second tabs 215 may have provided on each second electrode 212. The pair of second tabs 215 formed on each second electrode 212 may be arranged in a row in the Z-axis direction.

The case 220 may form an approximate exterior of the battery 200 and accommodate the electrode assembly 210 therein. The case 220 may include a conductive metallic material such as aluminum, an aluminum alloy, or nickel-plated steel.

The case 220 may include a bottom portion 221, a first side portion 222, and a second side portion(not shown). The bottom portion 221 may form a lower outer surface of the case 220. The bottom portion 221 may have a rectangular plate shape. The first side portion 222 may extend from the bottom portion 221 and form a part of an outer side surface of the case 220. The second side portion may extend from the bottom portion 221 and form the remaining part of the outer side surface of the case 220.

The cap plate 230 may be coupled to the case 220 and seal the case 220. The cap plate 230 may be formed to have a flat plate shape. The cap plate 230 may be disposed to face the case 220 in the Z-axis direction. For example, an inner surface of the cap plate 230 may be disposed to face an open upper surface of the case 220. The cap plate 230 may be disposed parallel to the bottom portion 221 of the case 220.

The terminals 240a and 240b may be coupled to the cap plate 230 and may protrude outward from the cap plate 230. The terminals 240a and 240b may pass through the cap plate 230 in the Z-axis direction. An upper end portion of each of the terminals 240a and 240b may protrude outward from the cap plate 230, and a lower end portion of each of the terminals 240a and 240b may protrude into the interior of the case 220. The specific shapes of the terminals 240a and 240b are not limited to the shapes illustrated in FIG. 3 or 4, and may be designed to have various shapes.

The terminals 240a and 240b may be electrically connected to the electrode assembly 210. The terminals 240a and 240b may be formed of an electrically conductive material, such as aluminum, nickel, or copper. The terminals 240a and 240b may be provided as a pair of terminals 240a and 240b. The pair of terminals 240a and 240b may be disposed to be spaced a predetermined interval apart on the cap plate 230 in the Y-axis direction. The pair of terminals 240a and 240b may be disposed at the edges of both sides of the cap plate 230.

The pair of terminals 240a and 240b may be individually connected to the first electrode 211 and the second electrode 212 of the electrode assembly 210. For example, one terminal 240a of the pair of terminals 240a and 240b may be connected to the first tab 214 and function as a positive electrode terminal of the battery 200, and the other terminal 240b may be connected to the second tab 215 and function as a negative electrode terminal. Each of the terminals 240a and 240b may be connected to the first tab 214 or the second tab 215 either directly or through current collectors 241 and 242.

An insulator G may be installed between the electrode assembly 210 and the cap plate 230. A pair of insulators G may be provided. The pair of insulators G may be spaced apart from one another in the Y-axis direction between the electrode assembly 210 and the cap plate 230. The pair of insulators G may be disposed to individually surround the respective terminals 240a and 240b. The insulator G may be made of an insulating material such as polyethylene (PE), polypropylene (PP), polyethylene terephthalate (PET), rubber, or the like.

The vent 250 may be provided on the cap plate 230 and may open and close in response to the internal pressure of the case 220. The vent 250 may function as a configuration that provides a discharge path for gases, flames, or smoke generated inside the case 220 when the internal pressure of the case 220 exceeds a predetermined threshold due to overcurrent, thermal runaway, or the like. The vent 250 may be disposed between the pair of terminals 240a and 240b.

The bus bar 300 may electrically connect the terminals 240a and 240b provided on a pair of adjacent batteries 200 among the plurality of batteries 200. For example, one side of the bus bar 300 may be welded to the positive terminal 240a of the battery 200, and the other side of the bus bar 300 may be welded to the negative terminal 240b of an adjacent battery 200. The bus bar 300 may be formed of a conductive metallic material. Alternatively, the bus bar 300 may connect the plurality of batteries 200 in parallel, or in a combination of series and parallel configurations.

As the plurality of batteries 200 are arranged side by side in the X-axis direction, a plurality of bus bars 300, each electrically connecting the terminals 240a and 240b provided in a pair of adjacent batteries 200, may also be arranged in a row in the X-axis direction. However, since each prismatic battery 200 includes a pair of terminals 240a and 240b disposed at the edges of both sides of the cap plate 230 and the plurality of batteries are arranged in a row in the X-axis direction, the bus bars 300 arranged in a row in the X-axis direction for a single row of the batteries 200 may include two rows. That is, the bus bar 300 may include a first row bus bar 300a arranged in the X-axis direction, and a second row bus bar 300b arranged in the X-axis direction and spaced predetermined interval apart from the first row bus bar 300a in the Y-axis direction.

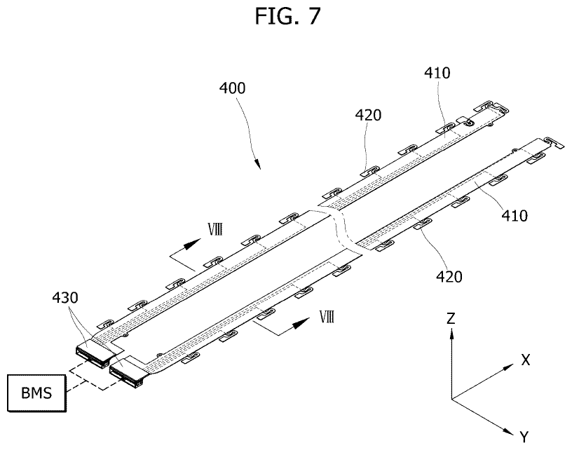

The sensing circuit member 400 may be connected to the bus bar 300, or the like and transmit status signals of the battery 200, such as signals regarding voltage and temperature, to a battery management system BMS (see FIG. 7). More specifically, one end portion of the sensing circuit member 400 may be electrically connected to the bus bar 300, and the other end portion may be connected to the battery management system BMS, thereby transmitting voltage information of the battery 200 connected to the bus bar 300 to the battery management system BMS. In addition, the one end portion of the sensing circuit member 400 may be connected to a thermistor (not illustrated) that is in contact with one surface of the bus bar 300 or the battery 200, and the other end portion may be connected to the battery management system BMS, thereby transmitting temperature information of the battery 200 to the battery management system BMS.

The sensing circuit member 400 may also transmit control signals from the battery management system BMS to the battery 200. For example, a control signal based on the status information of the battery 200, such as voltage or temperature, received by the battery management system BMS through the sensing circuit member 400, may be transmitted to the battery 200 through the sensing circuit member 400.

According to embodiments of the present disclosure, the sensing circuit member 400 may be implemented using a flat cable. The flat cable may be a member in which a plurality of circuits or wires are embedded inside an electrically insulating material that is flexible and has a predetermined width. For example, the flat cable may be a flexible flat cable (FFC), a flexible printed circuit (FPC), a flexible die-cut circuit (FDC), or the like.

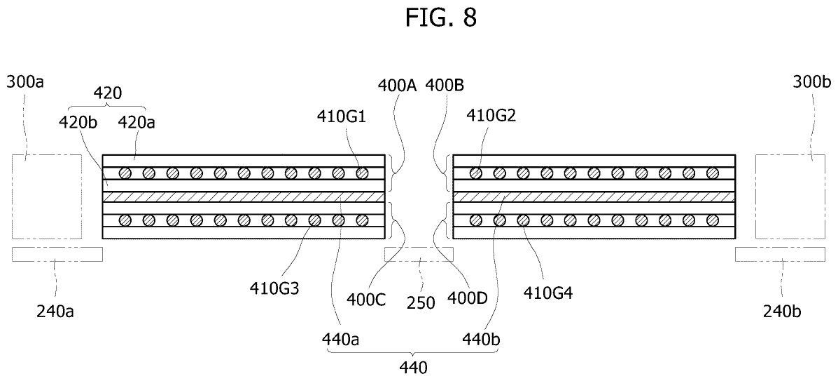

FIG. 7 is an enlarged perspective view illustrating two sensing circuit members illustrated in FIG. 6. FIG. 8 is a cross-sectional view along line VIII-VIII in FIG. 7. In FIG. 8, the locations of some components (terminals 240a and 240b, the vent 250, and the bus bars 300a and 300b) of the battery 200 are illustrated to specifically illustrate the placement of the sensing circuit member in the energy storage module 20. Referring to FIGS. 7 and 8, the sensing circuit member 400 may include a wiring line 410 and an insulating film 420.

The wiring line 410 is a member for transmitting signals between the bus bar 300 or the battery 200 and the battery management system BMS. One end of the wiring line 410 may be connected to the bus bar 300, and the other end may be connected to the battery management system BMS, thereby allowing signals to be transmitted between the bus bar 300 and the battery management system BMS. The wiring line 410 may be made of a typical metallic wire material used for wiring, such as copper.

The number of wiring lines 410 may be greater than the number of bus bars 300. For example, when the number of batteries 200 connected in series is 50 or more, the number of wiring lines 410 included in the sensing circuit member 400 may be 60 or more. The number of wiring lines 410 may increase in proportion to the number of bus bars 300, that is, the number of batteries 200 connected therethrough.

One end portion of the wiring line 410 may be connected to the bus bar 300 through a metal-to-metal bonding method such as welding. A plurality of wiring lines 410 may be connected to different bus bars 300 and/or batteries 200 through a method such as welding. In addition, the other end portion of the wiring line 410 may be connected to the battery management system BMS through a predetermined connecting member 430 such as a connector or the like.

The insulating film 420 is a member for embedding and fixing the plurality of wiring lines 410. The insulating film 420 may fixe the positions of the plurality of wiring lines 410 and prevent contact between adjacent wiring lines 410, thereby allowing each wiring line 410 to be electrically connected to different signals, i.e., different bus bars 300 and/or batteries 200. The material of the insulating film 420 is not particularly limited, and it may be formed of a polymer material such as polyimide or polyethylene.

Additionally, the insulating film 420 may protect the wiring line 410 from the external environment and electrically insulate the wiring line 410 by embedding the wiring line 410 therein. For example, the insulating film 420 may include an upper insulating film 420a and a lower insulating film 420b, and may have a configuration in which the upper insulating film 420a and the lower insulating film 420 b are bonded to one another with the wiring line 410 interposed therebetween. The upper insulating film 420a and the lower insulating film 420b may each be a coverlay in which one surface of a polyimide film is coated with an adhesive, but are not limited thereto.

The sensing circuit member 400 may be disposed at a position adjacent to the bus bar 300. For example, when the battery 200 is prismatic and the terminals 240a and 240b are located at the edges of both sides of the cap plate 230, the sensing circuit member 400 may be disposed between the pair of bus bars 300a and 300b, i.e., between the terminals 240a and 240b, on an upper side of the cap plate 230. When the sensing circuit member 400 is disposed at a location other than the upper side of the battery 200, the size of the electrodes 211 and 212 included in the battery 200 may be reduced accordingly, which is undesirable.

When a large number of wiring lines 410 are included in the sensing circuit member 400, it is difficult to connect all of the wiring lines 410 to the battery management system BMS by bundling the wiring lines 410 into a single connecting member (connector 430). In this case, the wiring lines 410 may be typically grouped into wiring line groups 410G1, 410G2, 410G3 and 410G4 each of which includes 10 to 15 wiring lines, and then each wiring line group 410G1 to 410G4 is bundled into the connector 430 to be connected to the battery management system BMS. For example, when the number of wiring lines 410 is approximately 60, rather than bundling all of the wiring lines 410 into a single connector, the wiring lines 410 may be divided into four wiring line groups 410G1 to 410G4, each of which includes 15 wiring lines, and then four wiring line groups 410G1 to 410G4 are bundled into four or fewer connectors 430. That is, when the number of wiring lines 410 is great, the sensing circuit member 400 may be implemented as a plurality of sensing sub-circuit members 400A, 400B, 400C, and 400D, for example, four sensing sub-circuit members 400A, 400B, 400C, and 400D corresponding to four wiring line groups 410G1 to 410G4.

However, in the structure of the herein-described the energy storage module, which considers energy storage efficiency, the plurality of sensing sub-circuit members 400A, 400B, 400C, and 400D must all be disposed in the limited space on the upper sides of the batteries 200. For example, for single row of batteries, the plurality of sensing sub-circuit members 400A, 400B, 400C, and 400D may be disposed between the two rows of bus bars 300a and 300b. In this case, the plurality of sensing sub-circuit members 400A, 400B, 400C, and 400D may be disposed between the terminals 240a and 240b of the batteries 200.

However, the width between the pair of bus bars 300a and 300b, especially between the terminals 240a and 240b, is limited, and the vent 250 is typically located between the terminals 240a and 240b. Considering that the vent 250 serves as a path through which high-temperature/high-pressure gas generated inside the battery 200 is discharged, in order to prevent damage to the sensing sub-circuit members 400A, 400B, 400C, and 400D, it is desirable to arrange the sensing sub-circuit members 400A, 400B, 400C, and 400D as far apart from the vent 250 as possible without overlapping the vent 250. In particular, when the sensing sub-circuit members 400A, 400B, 400C, and 400D are the herein-described flat cables, they may be more vulnerable to heat due to the characteristics of the material of the insulating film 420.

In particular, considering that high temperature/high pressure gas is discharged upward from the vent 250, in order to prevent the sensing sub-circuit members 400A, 400B, 400C, and 400D from being directly damaged therefrom, it is preferable that the sensing sub-circuit members 400A, 400B, 400C, and 400D are disposed so as not to vertically overlap the vent 250. To this end, the plurality of sensing sub-circuit members 400A, 400B, 400C, and 400D, each having an elongated shape in the X-axis direction, are preferably disposed in two rows with a relatively small width but spaced a predetermined interval apart in the Y-axis direction, rather than being formed as a single planar member with a relatively large width (size in the Y-axis direction). That is, it is desirable to arrange the sensing sub-circuit members 400A, 400B, 400C, and 400D in two rows on the XY plane so that the sensing sub-circuit members 400A, 400B, 400C, and 400D are not located above the vent 250.

For example, a first row sensing sub-circuit members 400A and 400C may be disposed adjacent to the first row bus bar 300a, and a second row sensing sub-circuit members 400B and 400D may be disposed adjacent to the second row bus bar 300b. In this case, the first row sensing sub-circuit members 400A and 400C and the second row sensing sub-circuit members 400B and 400D may be disposed at a predetermined interval in the Y-axis direction so that the sensing sub-circuit members 400A, 400B, 400C, and 400D do not overlap the vent 250.

However, even with such an arrangement, when the number of wiring lines 410 is relatively great, it may be practically difficult to arrange all of the plurality of sensing sub-circuit members 400A, 400B, 400C, and 400D on a single plane (XY plane) in the space above the battery 200. For example, when the number of wiring lines 410 is 30 to 40 or more, it may be practically difficult to arrange the sensing sub-circuit members 400A, 400B, 400C, and 400D in two rows on a single XY plane while ensuring that the sensing sub-circuit members 400A, 400B, 400C, and 400D do not overlap the vent 250 between the terminals 240a and 240b of the battery 200 as much as possible.

According to the embodiments of the present disclosure, the plurality of sensing sub-circuit members 400A, 400B, 400C, and 400D, which constitute the sensing circuit member 400, are disposed in the space above the battery 200 in the Z-axis direction, that is, vertically stacked. For example, the first row sensing sub-circuit members 400A and 400C may be disposed to be vertically stacked, and in this case, among the first row sensing sub-circuit members 400A and 400C, the sensing sub-circuit member 400A on the upper side may be a first row upper sensing sub-circuit member, and the sensing sub-circuit member 400C on the lower side may be a first row lower sensing sub-circuit member. In addition, the second row sensing sub-circuit members 400B and 400D may be disposed to be vertically stacked, and in this case, among the second row sensing sub-circuit members 400B and 400D, the sensing sub-circuit member 400B on the upper side may be a second row upper sensing sub-circuit member, and the sensing sub-circuit member 400D on the lower side may be a second row lower sensing sub-circuit member.

Accordingly, the plurality of sensing sub-circuit members 400A, 400B, 400C, and 400D may be disposed in the space between the bus bars 300a and 300b, particularly in the space between the terminals 240a and 240b. In addition, the plurality of sensing sub-circuit members 400A, 400B, 400C, and 400D may be disposed as far apart from the vent 250 as possible, and particularly may be disposed so as not to vertically overlap the vent 250, or to overlap the vent 250 as little as possible.

In addition, heat insulating members 440a and 440b may be disposed between the sensing sub-circuit members that are stacked vertically, for example, between the first row sensing sub-circuit members 400A and 400C and the second row sensing sub-circuit members 400B and 400D. More specifically, a first heat insulating member 440a may be disposed between the first row upper sensing sub-circuit member 400A and the first row lower sensing sub-circuit member 400C, and a second heat insulating member 440b may be disposed between the second row upper sensing sub-circuit member 400B and the second row lower sensing sub-circuit member 400D. The first and second heat insulating members 440a and 440b may block heat transfer between the first row sensing sub-circuit members 400A and 400C, and between the second row sensing sub-circuit members 400B and 400D, respectively.

Accordingly, even when either of the upper sensing sub-circuit members 400A and 400B and the lower sensing sub-circuit members 400C and 400D are exposed to high heat and damaged, the propagation of heat to the other may be blocked. For example, when high-temperature debris discharged through the vent 250 falls onto the upper sensing sub-circuit members 400A and 400B, damage such as melting may inevitably occur in the insulating film 420 constituting the upper sensing sub-circuit members 400A and 400B. However, when the heat insulating members 440 are disposed between the upper sensing sub-circuit members 400A and 400B and the lower sensing sub-circuit members 400C and 400D, the spread of flames or debris to the lower sensing sub-circuit members 400C and 400D may be blocked. Therefore, it is possible to prevent damage to both the upper sensing sub-circuit members 400A and 400B and the lower sensing sub-circuit members 400C and 400D, thereby preventing a short circuit from occurring between the upper and lower wiring lines 410 provided therein.

The heat insulating member 440 may be formed of a material having excellent insulating properties. For example, the heat insulating member 440 may be formed of a mica sheet. However, the heat insulating member 440 is not limited thereto. The heat insulating member 440 may be manufactured to have a relatively thin thickness, and any material having excellent heat insulating properties may be used without limitation.

In the herein-described embodiments, the wiring line 410 constituting the sensing circuit member 400 is divided into four wiring line groups 410G1 to 410G4, thereby forming the four sensing sub-circuit members 400A, 400B, 400C, and 400D, which are stacked in two layers. However, depending on the implementation, the wiring line 410 constituting the sensing circuit member 400 may be divided into six or more groups, when the wiring lines 410 are divided into six groups, six sensing sub-circuit members, which are stacked in three layers, are formed. In this case, the heat insulating member may be disposed between the vertically adjacent sensing sub-circuit members.

According to embodiments of the present disclosure, sensing sub-circuit members included in a sensing circuit member are stacked and a heat insulating member is interposed between the vertically adjacent sensing sub-circuit members, thereby thermally insulating an upper sensing sub-circuit member and a lower sensing sub-circuit member. As a result, the propagation of fire or the like due to a short circuit between the upper sensing sub-circuit member and the lower sensing sub-circuit member can be prevented.

However, the effects obtainable through the present disclosure are not limited to the effects described herein, and other technical effects not mentioned will be clearly understood by those skilled in the art from the description of the disclosure described herein.

Although the present disclosure has been described herein by limited embodiments and drawings, the present disclosure is not limited thereto, and various modifications and variations may be made by those skilled in the art within the spirit of the present disclosure and the equivalent scope of the claims to be described herein.

What is claimed is:

1. An energy storage module comprising:
a plurality of batteries;
a plurality of bus bars that electrically connect the plurality of batteries; and
a wiring circuit member that transmits status information of each of the plurality of batteries to a battery management system (BMS) through a plurality of wiring lines connected to each of the plurality of bus bars,
wherein the wiring circuit member includes an upper wiring sub-circuit member and a lower wiring sub-circuit member that each includes a part of the plurality of wiring lines and are substantially vertically stacked.

2. The energy storage module of claim 1, wherein the wiring circuit member further includes a heat insulating member interposed between the upper wiring sub-circuit member and the lower wiring sub-circuit member.

3. The energy storage module of claim 2, wherein the heat insulating member includes a mica sheet.

4. The energy storage module of claim 1, wherein the wiring circuit member includes an insulating film in which the plurality of wiring lines are embedded.

5. The energy storage module of claim 4, wherein the insulating film includes a coverlay.

6. The energy storage module of claim 1, wherein the upper wiring sub-circuit member and the lower wiring sub-circuit member each includes a flat cable.

7. The energy storage module of claim 6, wherein the flat cable includes one or more of a flexible flat cable (FFC), a flexible printed circuit (FPC), and a flexible die-cut circuit (FDC).

8. An energy storage module comprising:
a plurality of prismatic batteries, each of which has a first terminal and a second terminal provided at edges of both sides of a cap plate and arranged in a row in a first direction;
a plurality of bus bars that include a first row bus bar and a second row bus bar, each of which is arranged in a row substantially in the first direction, and electrically connect the first terminal and the second terminal of adjacent prismatic batteries among the plurality of prismatic batteries; and
a wiring circuit member that transmits status information of each of the plurality of prismatic batteries to a battery management system (BMS) through a plurality of wiring lines connected to the plurality of bus bars, extends substantially in the first direction, and is disposed between the first row bus bar and the second row bus bar,
wherein the wiring circuit member includes an upper wiring sub-circuit member and a lower wiring sub-circuit member that each includes a part of the plurality of wiring lines and are substantially vertically stacked.

9. The energy storage module of claim 8, wherein the wiring circuit member further includes a heat insulating member interposed between the upper wiring sub-circuit member and the lower wiring sub-circuit member.

10. The energy storage module of claim 9, wherein the heat insulating member includes a mica sheet.

11. The energy storage module of claim 8, wherein the wiring circuit member includes an insulating film in which the plurality of wiring lines are embedded.

12. The energy storage module of claim 11, wherein the insulating film includes a coverlay.

13. The energy storage module of claim 8, wherein the upper wiring sub-circuit member and the lower wiring sub-circuit member each include a flat cable.

14. The energy storage module of claim 13, wherein the flat cable includes one or more of a flexible flat cable (FFC), a flexible printed circuit (FPC), and a flexible die-cut circuit (FDC).

15. The energy storage module of claim 8, wherein:
the upper wiring sub-circuit member includes a first row upper wiring sub-circuit member disposed adjacent to the first row bus bar and a second row upper wiring sub-circuit member disposed adjacent to the second row bus bar, and
the lower wiring sub-circuit member includes a first row lower wiring sub-circuit member disposed adjacent to the first row bus bar and a second row lower wiring sub-circuit member disposed adjacent to the second row bus bar.

16. The energy storage module of claim 15, wherein:
the cap plate further includes a vent provided between the first terminal and the second terminal,
the first row upper wiring sub-circuit member and the second row upper wiring sub-circuit member are spaced apart from one another so as not to overlap the vent, and
the first row lower wiring sub-circuit member and the second row lower wiring sub-circuit member are spaced apart from one another so as not to overlap the vent.

17. The energy storage module of claim 15, wherein the wiring circuit member further comprises:
a first heat insulating member interposed between the first row upper wiring sub-circuit member and the first row lower wiring sub-circuit member; and
a second heat insulating member interposed between the second row upper wiring sub-circuit member and the second row lower wiring sub-circuit member.

18. An energy storage system including a rack on which a plurality of energy storage modules are mounted,
wherein each of the energy storage modules includes:
a plurality of batteries;
a plurality of bus bars that electrically connect the plurality of batteries; and
a wiring circuit member that transmits status information of each of the plurality of batteries to a battery management system (BMS) through a plurality of wiring lines connected to each of the plurality of bus bars,
wherein the wiring circuit member includes an upper wiring sub-circuit member and a lower wiring sub-circuit member that each includes a part of the plurality of wiring lines and are substantially vertically stacked.

19. The energy storage system of claim 18, wherein the wiring circuit member further includes a heat insulating member interposed between the upper wiring sub-circuit member and the lower wiring sub-circuit member.

20. The energy storage system of claim 18, wherein the wiring circuit member includes an insulating film in which the plurality wiring lines are embedded.
